(19) United States
(12) Patent Application Publication
(10) Pub. No.: US 2026/0029012 A1
(43) Pub. Date: Jan. 29, 2026

(54) BOLT

(71) Applicant: STRONGDOR LIMITED, Lancashire (GB)

(72) Inventors: Terry Karl James, Lancashire (GB); Matthew Fritz Devenish, Lancashire (GB); Warwick Adrian Cane, Lancashire (GB); Stefan David Devenish, Lancashire (GB)

(21) Appl. No.: 19/279,327

(22) Filed: Jul. 24, 2025

(30) Foreign Application Priority Data
Jul. 25, 2024 (GB) 2410901.9

(51) Int. Cl. F16B 35/04

(52) U.S. Cl. CPC F16B 35/04

(57) ABSTRACT

The present disclosure relates to a cylindrical bolt for engaging a structure to a substrate, the cylindrical bolt comprising an external thread formed on an outer surface of the cylindrical bolt, wherein the external thread is configured to engage a complimentary shaped opening in the structure; a securing means at a first end of the cylindrical bolt, wherein the securing means is configured to enable the cylindrical bolt to be wound through the complimentary shaped opening in the structure to engage the structure with the substrate; an internal cavity extending through at least a portion of the cylindrical bolt; and an attachment receiving means, wherein the attachment receiving means is configured to enable an attachment to be attached to a second end of the cylindrical bolt in use.

### FIELD OF THE DISCLOSURE

The present disclosure relates to an improved bolt and, in particular, to a versatile bolt arrangement for actively and operatively engaging a structure with a substrate.

### BACKGROUND

Conventionally, when operatively coupling a structure, such as a frame of, for example, a door frame, a window frame, and so on, to a substrate, such as brick, wood, plasterboard, and so on, of, for example, an opening in a wall to which the frame is to be coupled thereto, a bolt may be installed in, or inserted through, the structure to actively and operatively engage the substrate when tightened, by winding, or screwing, the bolt.

However, a conventional bolt has limited application, limited flexibility in use, and limited functionality when engaging a structure to a substrate.

The present disclosure seeks to address, at least in part, the disadvantages and drawbacks of the conventional bolt described hereinabove.

### SUMMARY OF THE DISCLOSURE

According to a first aspect of the present disclosure there is provided a cylindrical bolt for engaging a structure to a substrate, the cylindrical bolt comprising: an external thread formed on an outer surface of the cylindrical bolt, wherein the external thread is configured to engage a complimentary shaped opening in the structure; a securing means at a first end of the cylindrical bolt, wherein the securing means is configured to enable the cylindrical bolt to be wound through the complimentary shaped opening in the structure to engage the structure with the substrate; an internal cavity extending through at least a portion of the cylindrical bolt; and an attachment receiving means, wherein the attachment receiving means is configured to enable an attachment to be attached to a second end of the cylindrical bolt in use.

In some embodiments, the cylindrical bolt may further comprise at least one further attachment receiving means, wherein the attachment receiving means and the at least one further attachment receiving means, independently or in any combination thereof, are configured to enable an attachment to be attached to the second end of the cylindrical bolt in use.

In some embodiments, an attachment receiving means may comprise an internal thread on an inner surface of the internal cavity of the cylindrical bolt. In some embodiments, the internal thread may be configured to receive a complimentary shaped attachment connection means of an attachment. In some embodiments, the complimentary shaped attachment connection means may have an external thread on an outer surface of the complimentary shaped attachment connection means.

In some embodiments, an attachment receiving means may comprise one or more indentations formed in the second surface of the cylindrical bolt. In some embodiments, the one or more indentations may form a circular groove. In some embodiments, two or more indentations may form predetermined segments in a substantially circular pattern. In some embodiments, the one or more indentations may form holes of a predetermined depth located at predetermined positions in the outer surface of the second end of the cylindrical bolt. In some embodiments, the one or more indentations may be configured to receive a complimentary shaped one or more attachment connection means of an attachment.

In some embodiments, the securing means may be a shaped receptacle configured to receive a correspondingly shaped tool. In some embodiments, the internal cavity may extend into the securing means shaped receptacle forming a hollow section through the cylindrical bolt. In some embodiments, the cylindrical bolt may further comprise a tapered section at the location where the internal cavity extends into the securing means shaped receptacle. In some embodiments, the tapered section may form a fixing screw countersink.

It will be appreciated that any features described herein as being suitable for incorporation into one or more aspects or embodiments of the present disclosure are intended to be generalisable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### DRAWINGS

Embodiments and examples of the present disclosure will now be described, by way of example only, and with reference to the accompanying drawings, in which:

FIG. 1a shows a schematic of a side view of a bolt according to one or more embodiments of the present disclosure.

FIG. 1b shows a schematic of a cross-sectional view of the bolt of FIG. 1a along the line AA, according to one or more embodiments of the present disclosure.

FIG. 1c shows a schematic of a further view of the bolt of FIG. 1a, according to one or more embodiments of the present disclosure.

FIG. 2a shows a schematic of a side view of a bolt with an acoustic attachment, according to one or more embodiments of the present disclosure.

FIG. 2b shows a schematic of a top view of the acoustic attachment, according to one or more embodiments of the present disclosure.

FIG. 2c shows a schematic of a cross-sectional view of the bolt with an acoustic attachment of FIG. 2a along the line AA, according to one or more embodiments of the present disclosure.

FIG. 2d shows a schematic of a cross-sectional view of the acoustic attachment of FIG. 2b along the line BB, according to one or more embodiments of the present disclosure.

FIG. 3a shows a schematic view of a strap attachment from below, according to one or more embodiments of the present disclosure.

FIG. 3b shows a schematic view of the strap attachment from above in which the strap attachment is connected to the bolt, according to one or more embodiments of the present disclosure.

FIG. 3c shows a schematic view of the strap attachment extending across a cavity, according to one or more embodiments of the present disclosure.

### DETAILED DESCRIPTION

In embodiments, the bolt of the present disclosure advantageously provides greater flexibility in use and enables the bolt to be utilised in various applications when actively and operatively engaging a structure to a substrate. In particular, the bolt can, in use, be paired with an attachment, e.g. operatively coupled to an attachment in use, to enable the advantageous bolt of the present disclosure to be utilised for numerous different applications, in different environments, and directed to solving different problems, when actively and operatively engaging a structure to a substrate. However, as will be appreciated, the bolt may be utilised without any attachment in order to attach, or securely engage, a structure to a substrate.

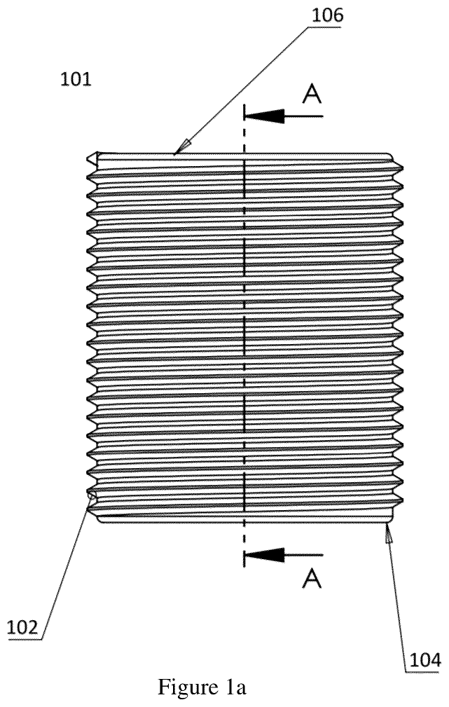

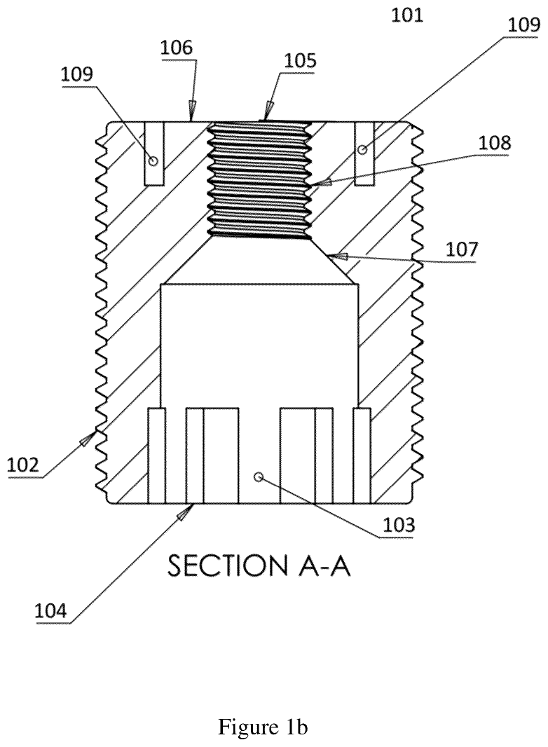

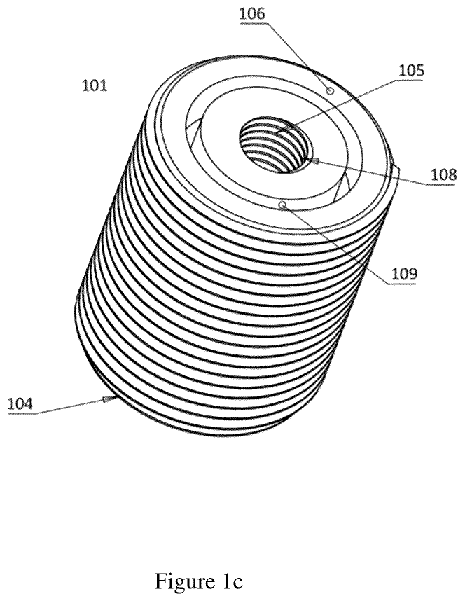

With reference to FIG. 1a, the bolt 101 is cylindrical in shape and comprises an external thread 102 on an external surface of the bolt. The cylindrical bolt 101 may be of any suitable dimensions to enable the bolt to secure a structure to a substrate. For example, the cylindrical bolt 101 may have a length of 30 millimetres (mm), and a diameter of 24 mm. However as will be appreciated, the dimensions of the cylindrical bolt may be of any suitable range, for example, the length may be between 20 mm and 100 mm, and the diameter may be between 10 mm and 50 mm.

In embodiments, the external thread 102 may engage with a complimentary sized and shaped opening in the structure (not shown) wherein the bolt can be operatively wound, or screwed, therethrough to hold the structure in engagement with the substrate. In embodiments, the external thread 102 may extend over the entire length of the outer surface of the cylindrical bolt, as shown in FIGS. 1a and 1b, whilst in other embodiments the external thread 102 may extend over a predetermined portion of the external surface of the cylindrical bolt, wherein the predetermined portion is sufficient for the bolt to extend through the structure and actively engage the structure with the substrate with, or without, an attachment.

The external thread 102 may of any suitable pitch and shape. For example, the pitch of the external thread may be 1.5 mm and of a triangular cross-sectional shape. However as will be appreciated, the pitch of the external thread may be any suitable pitch, for example, from 0.5 mm to 3 mm, and the cross-sectional shape of the external thread may be any suitable cross-sectional shape to enable the bolt to be tightened, e.g. wound or screwed, through a complimentary sized and shaped opening in the structure.

With reference to FIG. 1b, the bolt further comprises a securing means 103 wherein the securing means may be any suitable means for enabling the bolt to be tightened, e.g. by winding or screwing, through the complimentary sized opening in the structure. The securing means 103 may be formed in a first end 104 of the bolt 101. For example, the securing means may be a shaped receptacle, e.g. a hexagonal, a square, a rectangle, a triangle, a cross, a slit or indentation, and so on, shaped receptable, to receive a correspondingly sized and shaped tool to engage with the securing means of the bolt to enable the bolt to be tightened, e.g. by winding or screwing, through the complimentarily sized opening in the structure. In the example shown in FIG. 1b, the securing means is a hexagonal shaped receptacle with a cross-sectional diameter of 15.5 mm and a length of 15 mm. However as will be appreciated, the dimensions of the securing means may be of any suitable range, for example, the length may be between 10 mm and 50 mm, and the cross-sectional diameter may be between 10 mm and 40 mm.

The bolt further comprises an internal cavity 105 extending through at least a portion of the bolt from a second end 106 of the bolt, distal to the first end, to a predetermined location proximate to the securing means 103. In embodiments, the internal cavity 105 may include an opening at the predetermined location at which the securing means meets the internal cavity to form a hollow section through the cylindrical bolt. In embodiments, the opening is a tapered section 107 to form a fixing screw countersink, such that the internal cavity enables a fixing screw (not shown in FIG. 1) to be inserted through both the securing means 103 and the internal cavity 105, to engage with the tapered opening 107, and to protrude a predetermined distance from a surface of the second end of the bolt to engage with the substrate.

In embodiments, the internal cavity 105 is cylindrical in shape and may be of any suitable dimensions, for example, the internal cavity may have a diameter of 7 mm and a length of 10 mm. However as will be appreciated, the dimensions of the cylindrical internal cavity may be of any suitable range, for example, the length may be between 5 mm and 30 mm, and the diameter may be between 5 mm and 30 mm.

The bolt further comprises an attachment receiving means, or at least one attachment receiving means. In the examples shown in FIG. 1, the cylindrical bolt includes two attachment receiving means 108, 109, however, as will be appreciated there may be any number of attachment receiving means incorporated in and/or on the cylindrical bolt. In embodiments, the (or each) attachment receiving means, independently or, when two or more attachment receiving means, in any combination thereof, are configured to enable an attachment to be operatively attached, or paired with, e.g. fixed, or operatively connected, to the bolt in use, to enable the bolt to be utilised for different applications.

In embodiments, the bolt may include an attachment receiving means 108 that includes an internal thread positioned on an inner surface of the internal cavity of the bolt. In embodiments, the bolt may include an attachment receiving means 109 that includes one or more indentations located in the outer surface of the second end 106 of the bolt. In embodiments, the bolt may include two attachment receiving means 108, 109, in which a first attachment receiving means 108 corresponds to an internal thread positioned on an inner surface of the internal cavity of the bolt and a second attachment receiving means 109 corresponds to one or more indentations located in the outer surface of the second end 106 of the bolt. In the following examples, and embodiments, and as shown in FIG. 1, a bolt will be described that includes both of the two attachment receiving means mentioned above.

The first attachment receiving means 108, corresponding to the internal thread, is configured to enable an attachment with a complimentary shaped attachment connection means, e.g. a protrusion having an external thread thereon, to be operatively and securely screwed into the first attachment receiving means of the bolt so as to in use fix the attachment to the bolt. The internal thread may be formed along the whole length of the internal cavity 105 or may be formed along a portion thereof. The internal thread may of any suitable pitch and shape. For example, the pitch of the external thread may be 0.7 mm and of a triangular cross-sectional shape. However as will be appreciated, the pitch of the external thread may be any suitable pitch, for example, from 0.5 mm to 3 mm, and the cross-sectional shape of the external thread may be any suitable cross-sectional shape to enable a corresponding protrusion having an external thread thereon to be tightened, e.g. wound, or screwed, into the first attachment receiving means.

The second attachment receiving means 109, corresponding to one or more indentations located in the outer surface of the first end of the bolt, may be formed as a single continuous circular indentation, e.g. a groove, or ridge, in the outer surface of the first end of the bolt, or may be formed of two or more predetermined segments of a circular shaped indentation, e.g. two, four, six, or eight segments, or may be formed of one or more shaped holes, e.g. circular, square, rectangular, triangular, hexagonal, and so on, located at predetermined positions in the outer surface of the second end of the bolt, such that they are configured to enable an attachment to be securely attached to the bolt in use. In the example shown in FIGS. 1b and 1c, the second attachment receiving means 109 is a continuous circular indentation, e.g. a groove, that is formed in the outer surface of the second end 106 of the bolt, wherein the second end of the bolt is, in use, engaging the structure with the substrate, either directly or indirectly via an attachment.

The shape and dimensions of the indentation(s) of the second attachment receiving means 109 may be of any suitable shape and dimension for the purpose of receiving an attachment. For example, the circular groove shown in FIGS. 1b and 1c may be of a width of 1.5 mm and a depth of 5 mm. However as will be appreciated, the dimensions of the second attachment receiving means may be of any suitable range, for example, the width may be between 0.5 mm and 15 mm, and the depth may be between 1 mm and 15 mm.

The one or more indentations of the second attachment receiving means 109 enables an attachment with complimentary shaped and sized attachment connection means, e.g. protrusion(s), to be, in use, pushed into, and/or securely held by, the indentation(s) in the outer surface of the second end of the bolt to fixedly attach the attachment to the bolt.

The advantageous features of the bolt, i.e. to include one or more attachment receiving means, enables the bolt to be utilised for different applications, and to provide a secure engagement of the structure with the substrate under different conditions, environments, or configurations. For example, attachments may include one or more of an acoustic dampening attachment, a straps attachment for fixing the structure to the substrate across a cavity, a foot attachment to prevent the bolt from digging into the substrate, and so on. As will be appreciated, there may be any number of different attachments that could be paired, or used, with the bolt to provide a wide range of applications, functionality, and to address different fixing conditions, configurations, and environments. The one or more attachment receiving means provides the advantageous technical feature that enables the bolt to potentially be utilised for any number of applications when securely fixing, or engaging, the structure to the substrate, irrespective of the actual attachment (if any) that could be paired with the bolt in use.

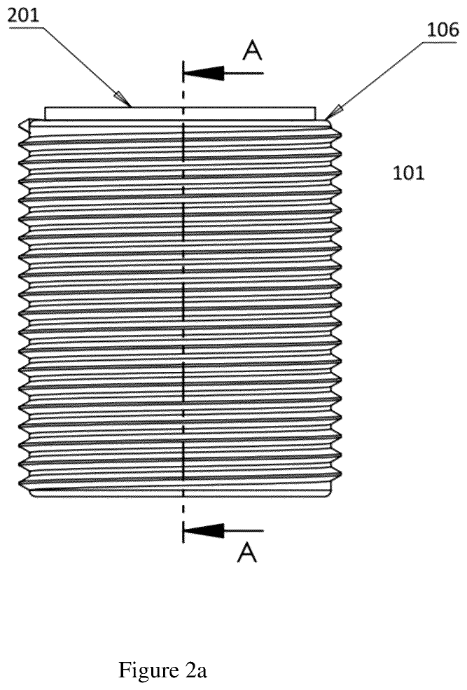

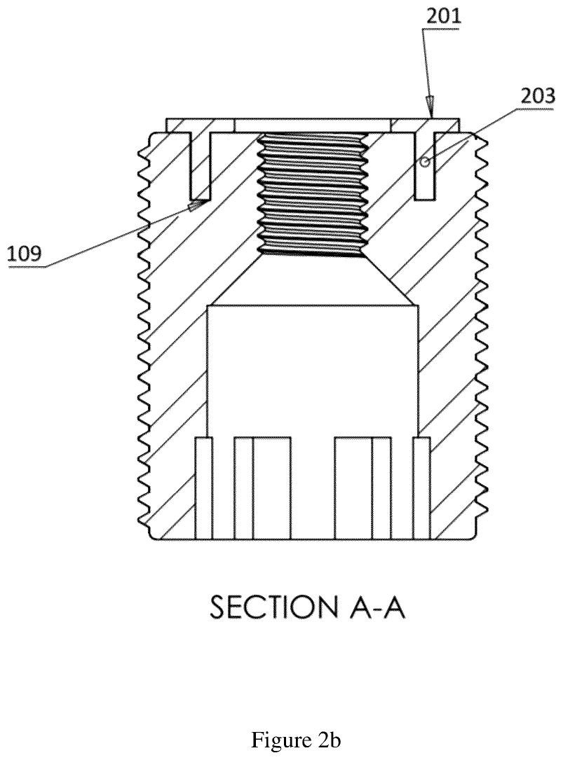

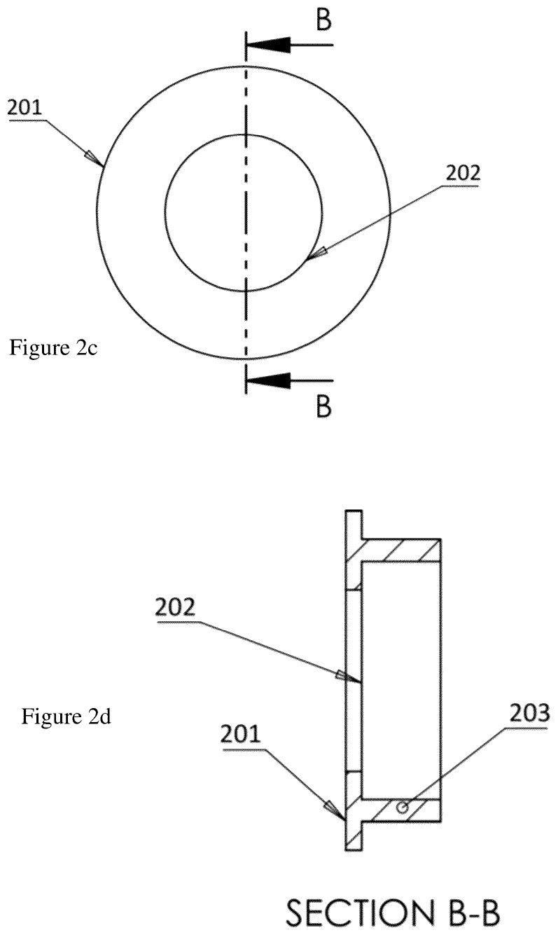

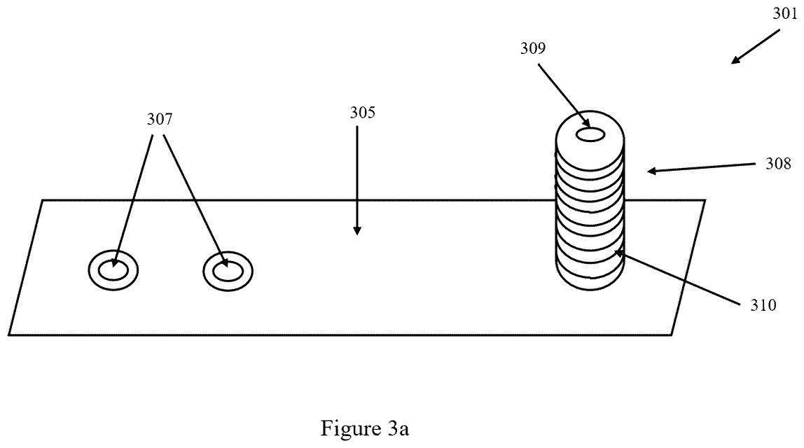

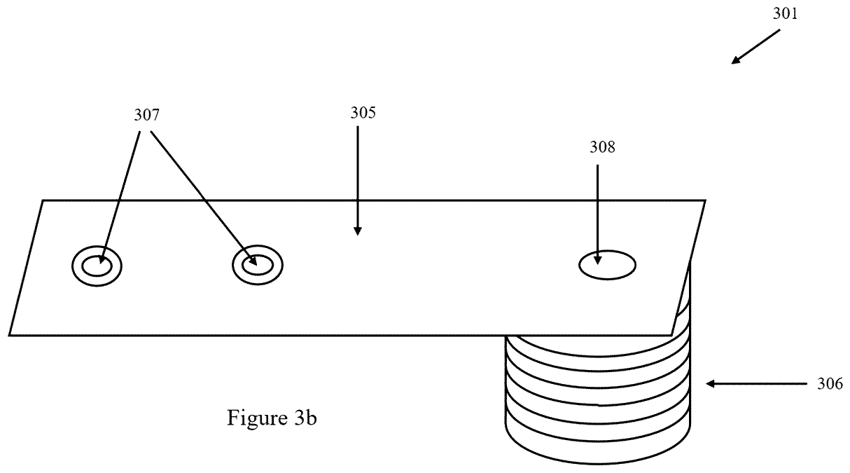

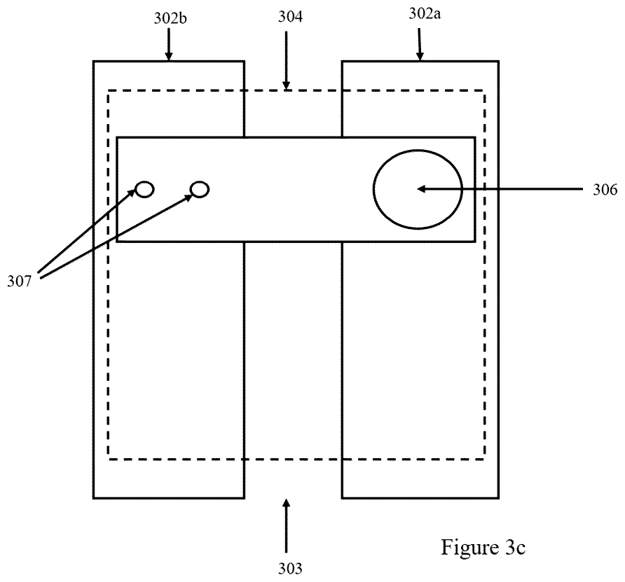

Two example attachments will now be described with reference to FIGS. 2 and 3, utilising each of the two attachment receiving means. However, as will be appreciated, an attachment could utilise both of the attachment receiving means in combination, e.g. simultaneously.

FIGS. 2a to 2d schematically show an acoustic dampening attachment 201 that is engaged with the bolt 101 utilising the second attachment receiving means 109 to improve the acoustic rating of the structure when engaged with the substrate. As shown in FIG. 2a, the acoustic dampening attachment 201 is positioned on the second end 106 of the bolt. This acoustic dampening attachment may be formed of a suitable acoustic dampening material, for example, rubber, and of a substantially circular, e.g. a disc, shape to match the circular section of the second end of the bolt. Therefore, circular shape may have a diameter that matches, or substantially matches, the diameter of the surface of the second end of the bolt. In embodiments, and as shown in FIG. 2b, the acoustic attachment further includes a central hole 202 with a diameter that matches, or substantially matches, the diameter of the internal cavity 105 of the bolt. The central hole 202 enables a fixing screw, if required, to pass therethrough unhindered or to enable a further attachment to be operatively attached to the bolt and connected to the internal thread of the internal cavity of the bolt, if required. In other embodiments, the acoustic attachment may be a flat disk shape without a central hole, wherein any fixing screw, if required, can be screwed through, and protrude from the acoustic attachment.

As shown in FIGS. 2c and 2d, in embodiments the acoustic attachment includes an attachment connection means 203, which in this example is a continuous circular protrusion, that is shaped and dimensioned to match the second attachment receiving means 109, which in this example is a circular groove indentation, in the surface of the second end of the bolt.

Thus, the acoustic dampening attachment may be fixedly connected to, or engaged with, the bolt by pushing the circular protrusion (i.e. the attachment connection means 203) into the circular groove (i.e. the second attachment receiving means 109). The connection will be maintained when the bolt is tightened so as to engage the structure with the substrate.

A strap attachment will now be described with reference to FIGS. 3a to 3c, in which FIG. 3a is a perspective view of the strap attachment from below, FIG. 3b is a perspective view of the strap attachment from above in which the strap attachment is connected to the bolt, and FIG. 3c shows the strap attachment extending across a cavity.

The strap attachment 301 may be configured to enable the structure 304 to be fixedly engaged with a substrate that includes a cavity 303. For example, in many constructions of a building a substrate, e.g. a wall, can be formed of two sections 302a, 302b, which may be referred to as wall skins, with a cavity 303 therebetween. It can be a challenge to engage a structure 304 (only a portion of the structure is shown in FIG. 3c) such as a door, or window, frame to the substrate that includes a cavity 303 as a portion of the bolt 306 may overlap with the cavity 303 and typically there is no connection between the structure and the second section of the substrate 302b, meaning that the fixing of the structure to the substrate may not be fully secure.

The strap attachment may be formed of rigid, or flexible, material portion 305 that provides sufficient strength to securely attach the structure, e.g. a door frame, to the substrate that includes a cavity. The strap attachment may be sized based on the dimensions of the substrate sections and the cavity, in particular the widths of the substrate sections and the cavity, such that the length of the material portion is sufficient to reach between the substrate sections across the cavity. For example, the length of the material portion may range between 200 mm and 500 mm, however, as will be appreciated, the length of the material portion may be less than or longer than the above-mentioned range depending on the specific dimensions of the substrate sections and the cavity therebetween. In addition, the width of the material portion may range between 50 mm to 200 mm, however, as will be appreciated, the width may be narrower or wider than the above-mentioned range as required based on the installation arrangement.

In embodiments, the strap attachment 301 may extend substantially perpendicular to the surface of the second end of the bolt, wherein the bolt 306 in use is engaging with at least a portion of the first section 302a of the substrate, to the second section 302b of the substrate 302 across the cavity 303. The strap attachment 301 may then be fixed by any suitable means, such as by fixing screws positioned through holes 307 in the material portion 305, to the second section 302b of the substrate.

The strap attachment 301 includes an attachment connection means 308 which, in this example, includes a protrusion with a thread 310 on an outer surface thereof, which is shaped and dimensioned to securely engage with the first attachment receiving means of the bolt, i.e. the internal thread of the internal cavity of the bolt. The strap attachment 301 may therefore be wound, or screwed, into the bolt 306 either prior to, or during, tightening of the bolt to engage the structure 304 with the first section 302a of the substrate. The attachment connection means 308, e.g. the protrusion in this example, may be solid or hollow. In the case that the protrusion is hollow 309, this enables a fixing screw (not shown in FIGS. 3a to 3c) to be inserted through the bolt and the strap attachment and protrude therefrom and extend into the substrate.

In the above-described examples and embodiments, a single bolt of the present disclosure was utilised at any one location in the structure. However, as will be appreciated, two or more bolts may be utilised in combination proximate to each other at any one location to engage the structure to the substrate, where the additional bolts may have the same or different attachments operatively connected thereto. Depending on the size of the structure, e.g. door frame, window frame, and so on, there may be two or more locations in the structure at which a bolt (or combination of bolts) may be utilised to actively and securely engage the structure to the substrate, e.g. a wall of a wall opening.

In the foregoing embodiments, features described in relation to one embodiment or example may be combined, in any manner, with features of a different embodiment in order to provide a more efficient and effective bolt for engaging a structure with a substrate. Note that, the above description is for illustration only and other embodiments and variations may be envisaged without departing from the scope of the invention as defined by the appended claims.

1. A cylindrical bolt for engaging a structure to a substrate, the cylindrical bolt comprising:
an external thread formed on an outer surface of the cylindrical bolt, wherein the external thread is configured to engage a complimentary shaped opening in the structure;
a securing means at a first end of the cylindrical bolt, wherein the securing means is configured to enable the cylindrical bolt to be wound through the complimentary shaped opening in the structure to engage the structure with the substrate;
an internal cavity extending through at least a portion of the cylindrical bolt; and
an attachment receiving means, wherein the attachment receiving means is configured to enable an attachment to be attached to a second end of the cylindrical bolt in use.

2. The cylindrical bolt of claim 1, further comprising:
at least one further attachment receiving means, wherein the attachment receiving means and the at least one further attachment receiving means, independently or in any combination thereof, are configured to enable an attachment to be attached to the second end of the cylindrical bolt in use.

3. The cylindrical bolt of claim 1, wherein an attachment receiving means comprises:
an internal thread on an inner surface of the internal cavity of the cylindrical bolt.

4. The cylindrical bolt of claim 3, wherein the internal thread is configured to receive a complimentary shaped attachment connection means of an attachment.

5. The cylindrical bolt of claim 1, wherein an attachment receiving means comprises:
one or more indentations formed in the second surface of the cylindrical bolt.

6. The cylindrical bolt of claim 5, wherein the one or more indentations form a circular groove.

7. The cylindrical bolt of claim 5, wherein two or more indentations form predetermined segments in a substantially circular pattern.

8. The cylindrical bolt of claim 5, wherein the one or more indentations form holes of a predetermined depth located at predetermined positions in the outer surface of the second end of the cylindrical bolt.

9. The cylindrical bolt of claim 5, wherein the one or more indentations are configured to receive a complimentary shaped one or more attachment connection means of an attachment.

10. The cylindrical bolt of claim 1, wherein the securing means is a shaped receptacle configured to receive a correspondingly shaped tool.

11. The cylindrical bolt of claim 10, wherein the internal cavity extends into the securing means shaped receptacle forming a hollow section through the cylindrical bolt.

12. The cylindrical bolt of claim 11, further comprising a tapered section at the location where the internal cavity extends into the securing means shaped receptacle.

13. The cylindrical bolt of claim 12, wherein the tapered section forms a fixing screw countersink.
